(19) United States
(12) Patent Application Publication
(10) Pub. No.: US 2024/0119097 A1
(43) Pub. Date: Apr. 11, 2024

(54) PROVIDING RECENT EVENT INFORMATION FOR WEB SEARCH QUERIES

(71) Applicant: Microsoft Technology Licensing, LLC, Redmond, WA (US)

(72) Inventors: Manoj Kumar AGARWAL, Hyderabad (IN); Gandhi Rajeshkumar RONNIE, Surat (IN)

(21) Appl. No.: 18/263,265

(22) PCT Filed: Jan. 13, 2022
(86) PCT No.: PCT/US2022/012337

§ 371 Date: Jul. 27, 2023

(30) Foreign Application Priority Data
Feb. 25, 2021 (LU) LU102575

(51) Int. Cl. G06F 16/9535; G06F 16/955

(52) U.S. Cl. CPC G06F 16/9535; G06F 16/955

(57) ABSTRACT

An electronic device may identify one or more search queries occurring frequently in a query log during a temporal period and maintain, for each of the one or more search queries, a frequency count of the search query occurring in the query log. The device may identify, a plurality of uniform resource locators (URLs) and match, one or more URLs of the plurality of URLs based on text of the URLs. The device may generate a news event profile for each search query and add each of the matching URLs into a respective news event profile. The device may receive a query from a user and identify, a matching news event profile. The device causes URLs of the matching news event profile and one or more related search queries from the first group of search queries to be presented to the user.

### CLAIM FOR PRIORITY

This application claims the benefit of priority of Luxembourg Patent Application No. LU102575, filed Feb. 25, 2021, which is hereby incorporated by reference in its entirety.

### TECHNICAL FIELD

The subject matter disclosed herein generally relates to generating new query suggestions and providing recent event information to users for web search queries in accordance with some embodiments or examples.

### BACKGROUND

Breaking news stories capture the attention of local and global audiences. Information related to news events are shared widely via the internet and allow quick dispersion of information pertaining to the day's events. However, as the world becomes more connected, updates related to more events compete for people's attention.

### SUMMARY

A method and apparatus provide recent event information to users based on query logs. Based on a frequency of various users' search queries received by a search engine, a news event profile is generated. The news event profile includes one or more URL links to articles covering the news event. The one or more URL links of the news event profile are provided to the user. A generated timeline of the news event is also optionally provided to the user along with the one or more URL links of the news event profile.

In one example, a user provides a search request for a news event. In accordance with the received search request, related search queries are suggested to the user. Additionally, a pre-generated news event profile is found to match the search request by the user. In response to such a match, the one or more URL links of the matching news event profile are provided for the user.

To reduce processing burden, URLs are selected from a plurality of news sources that have been pre-determined to provide reliable news related information.

This Summary is provided to introduce a selection of concepts that are further described below in the Detailed Description. It is not intended to identify key features or essential features of the claimed subject matter, nor it is intended to be used to limit the scope of the claimed subject matter.

### BRIEF DESCRIPTION OF THE DRAWINGS

The disclosed aspects will hereinafter be described in connection with the appended drawings that are provided to illustrate and not to limit the disclosed aspects.

FIG. 1 is a block diagram of an example computer system providing related search queries in accordance with some embodiments.

FIGS. 2 and 3 depict an example flow diagram for providing fresh query suggestions to a user in accordance with some embodiments.

FIGS. 4A, 4B, and 4C show an example diagram for generating and viewing news-event related content in accordance with some embodiments.

FIG. 5 is a block diagram of an example networked system depicting an environment in which embodiments may operate.

FIG. 6 is a block diagram of a computer system to implement one or more example embodiments.

### DETAILED DESCRIPTION

A particularly challenging issue exists for users attempting to consume news-related data. Typically, there is too much information for a user to sift through to obtain a comprehensive view of an event. Events may be quite complex, involving many players, and developing over time. Users are left to search many articles and may not receive the perspective or coverage of the event that he or she is looking for. A solution for providing news-related content in a concise and tailored manner is desired. Even more desired is a solution that provides a complete overview of all news-related events that have occurred on a given day.

Another particular challenge exists in providing news content to users without spending time and resources crawling web sites and news articles. Traditionally, news articles are provided to users based on (i) a number of links pointing to and from the URL in question or (ii) web-crawling to identify the relevance of the news article. These techniques are time consuming and resource intensive. Typically, by the time a processing device finishes vetting the URLs, the news event has passed, and the event is no longer relevant. Irrelevant news event reporting of past news events wastes network bandwidth and resources. Quick access to each day's news updates would allow people to understand what is happening within their locality as well as around the world.

An electronic device may receive a query log including query-URL pairs for a first time period. In some embodiments, each query-URL pair includes one query and one URL received in the query log from a search engine. The query-URL pairs are received from the search engine as a query log of queries received at the search engine, and the corresponding URL provided in response to the query. In some embodiments, the query-URL pair includes multiple URLs. The query-URL pairs are grouped into a plurality of clusters to identify a first pattern of frequently occurring key words in a first cluster of the plurality of clusters. Then a popularity score is assigned, indicative of a frequency of the first pattern in the first cluster. The electronic device may subsequently compute a cumulative popularity score for the first pattern in the plurality of clusters. Then, a set of URLs associated with the query-URL pairs for the first pattern is extracted to identify a first sub-set of URLs originating from a news domain of a plurality of preselected news domains. The electronic device may assign a news affinity score to the pattern based at least in part on a percentage of URLs of the first sub-set of URLs originating from a news domain of the plurality of preselected news domains. A first news event profile is generated for the first pattern and one or more URLs of the first sub-set of URLs are caused to be presented to a user. For each day, a number of URLs are selected (e.g., between 6-25) and of the selected URLs, a subset is displayed (e.g., 4-5 URLs). Methods and systems disclosed herein provide up-to-date news event related information to users. For example, a user browsing the internet lands on a search engine's home page. The home page, or dashboard page may include updates on the daily news, stock market updates, the local weather, and other pertinent things a user would probably like to know about. However, important, and/or interesting news events may become lost or buried among competing events, stories, or notifications. The methods and systems disclosed herein provide a user with recent event information tailored to the specific day's events. Additionally, a curated page may be provided to a user in response to a user query matching key words of a news event profile. One or more URLs pertaining to the news event profile along with a corresponding timeline and/or fresh query suggestions may be presented to the user. To that end, the methods and systems described herein generate a data structure for news events storing event profiles and/or user information to tailor news events to a user's preference. The data structure produced by a processing device can include a pattern, a unique identifier assigned to each pattern, a pattern score, a list of clusters (also called HashCodeList), the query in which the pattern appeared, and one or more URLs associated with the pattern. Additionally, related news events, URLs, or search query suggestions are provided to the user.

A computer implemented system efficiently identifies a news event, prepares timelines via URLs from verified news sources, and offers one or more suggested related search queries to allow a user to consume the requested information without the processing device expending precious resources and time to prepare the information when requested by the user (e.g., at runtime). In some embodiments, the computer implemented system is trained to perform the operations discussed herein as a preparatory or anticipatory process. Whether the user requests to view the news related content or not, the system has them prepared.

Further, a useful technical solution of identifying news related events and providing content related to the news related event provides a clever improvement in solving the technical problem of providing time sensitive news information without the delay associated with waiting for web-crawlers or other time-consuming mechanisms when a user request is received. Additionally, utilizing URLs from query-URL pairs determined to be news-related events significantly reduces processing time required of the computing system to provide a curated deliverable of news-related information as well for a user looking to consume the information as efficiently as possible. By using the methods and systems described herein, the processing time is reduced at the same time increasing fidelity in the newsworthy-ness of the identified URLs.

It is understood that the system may also be used to provide other time sensitive information, or information regarding events that take place over an extended period of time.

The inventive subject matter will now be discussed with reference to several example implementations. It is to be understood that these implementations are discussed for enabling those skilled in the art to better understand and thus implement the embodiments of the present disclosure, rather than suggesting any limitations on the scope of the present disclosure.

Examples disclosed herein are directed to methods, apparatus comprising several modules, and apparatus comprising one or more processors and memory embodied with executable instructions for providing recent event information to a user. Using the disclosed examples, a device is equipped with a search engine that can receive, process, and deliver information about news events. A “search engine” may be referred to the entire device and software components for searching data that includes images and presenting identified image information to the user. The search engines disclosed herein may utilize one or more types of artificial intelligence including but not limited to machine learning, neural network, deep learning, computer vision, and natural language processing.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term “article of manufacture,” as used herein is intended to encompass a computer program accessible from any computer-readable storage device or media. Computer-readable storage media can include, but are not limited to, magnetic storage devices (e.g., hard disk, floppy disk, magnetic strips, optical disks, compact disks (CDs), digital versatile disks (DVDs), smart cards, flash memory devices). In contrast, computer-readable media, i.e., not storage media, may additionally include communication media such as transmission media for wireless signals and the like.

Having generally provided an overview of some of the disclosed examples, attention is drawn to the accompanying drawings to further illustrate some additional details. The illustrated configurations and operational sequences are provided to aid the reader in understanding some aspects of the disclosed examples. The accompanying figures are not meant to limit all examples, and thus some examples may include different components, devices, or sequences of operation while not departing from the scope of the disclosed examples discussed herein. In other words, some examples may be embodied or may function in different ways than those shown.

It should be noted that the above one or more aspects comprise the features hereinafter fully described and particularly pointed out in the claims. The following description and the drawings set forth in detail certain illustrative features of the one or more aspects. These features are only indicative of the various ways in which the principles of various aspects may be employed, and this disclosure is intended to include all such aspects and their equivalents.

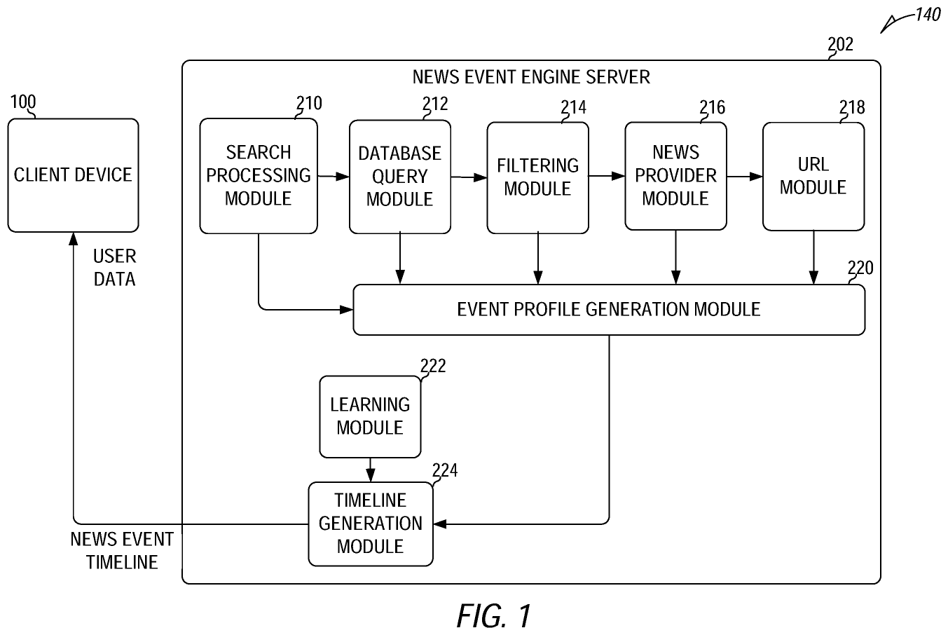

FIG. 1 is a block diagram of a system 140 for providing recent event information to a client device 100 using a news event profile generation module 220. The client device 100 may submit a search request or query 208 to the news event engine server 202. Additionally, and or alternatively, the news event engine server 202 may be executed on client device 100.

In some examples, a user of the client device 100 causes the client device 100 to transmit a search request to search processing module 210 of news event engine server 202. The search processing module 210 receives the request and provides the search request to a database query module 212. A filtering module 214 filters for similar search requests and/or news event profiles that have been previously generated. A news provider module 216 is used to identify URLs of a query-URL pair originating from a news domain. In some embodiments, the news provider module 216 filters for URLs originating from a news domain from a predetermined or preselected list of news domains/news providers (e.g., CNN, Times, CSNBC). A URL module 218 may fetch, sort, and/or selects one or more URLs to be provided to the user in response to the user's search request. A dynamic event profile generation module 220 generates a new or updated event profile (e.g., news event profile), the results of which may be sent to a timeline generation module 224 to generate a user interface having a timeline delineating the contents of the event profile including related URLs and alternative query suggestions for presentation to the user on the client device 100.

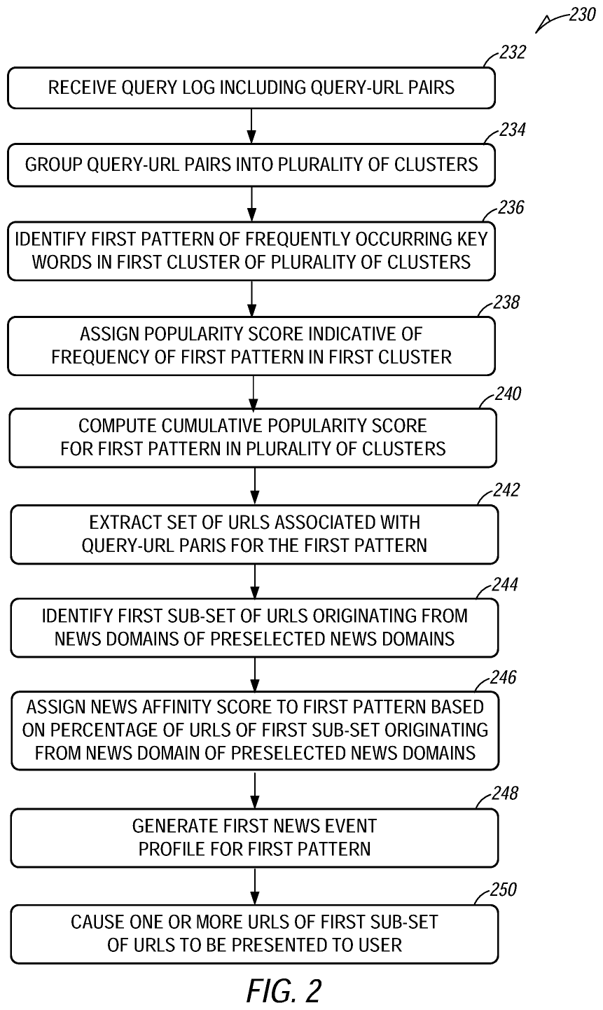

FIG. 2 is a flow diagram of an example method 230 for providing fresh news related URLs and fresh query suggestions to a user in accordance with some embodiments of the present disclosure. Fresh news related URLs are discovered using the process in method 230 and fresh query suggestions can also be determined by method 230 as a by-product of discovering the fresh news related URLs.

The method 230 can be performed by processing logic executing on a processing device that can include hardware (e.g., processing device, circuitry, dedicated logic, programmable logic), software (e.g., instructions run or executed on a processing device), or a combination thereof. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

Method 230 commences as the processing device (e.g., computing device) receives, at operation 232, a query log including query-URL pairs. The query log in one example includes a log of all queries received by a search engine and corresponding URLs discovered by the search engine in response to the received query. In some embodiments, the query log is a defined set of query-URL pairs received in a first time period (e.g., all query-URLs identified on Feb. 4, 2021).

At operation 234, the processing device groups the query-URL pairs of the query log into a plurality of clusters. In some embodiments, the query-URL pairs are divided into clusters of a specific size (e.g., 20 pairs) based on a semantic similarity between multiple query-URL pairs. For example, a first cluster may include 20 discrete query-URL pairs including words similar to “president” or “election.” By clustering the query-URL pairs into clusters based on semantic similarities, the processing device is primed to identify patterns within the clusters. The processing device then identifies a first pattern of frequently occurring key words in a first cluster of the plurality of clusters at operation 236. In some embodiments, the query-URL pairs are grouped into clusters by identifying query-URL pairs having a common URL.

The processing device then assigns a popularity score indicative of a frequency of the first pattern in the first cluster at operation 238. For example, a pattern is identified in a first cluster that includes the key words “president” and “Biden” and “2021.” A pattern typically includes two or more key words, and each cluster may include more than one pattern. For the identified first pattern, a popularity score is calculated by counting a frequency of the key word occurrence in the pattern. For each query log, the processing device identifies a popularity score of the searches in the cluster by:

fₚ=Σ_{q∈Q}f_{q}, Formula 1:
where phrase p appears in cluster c in a set of queries Q⊆C.

The frequency of the pattern found in the cluster is assigned a popularity score calculated as:

$${p}_{s} = log ( 1 + {f}_{p} ) \frac{s}{1 - c + ϵ} , where = \frac{\vert Q \vert}{\vert C \vert} and c = \frac{\vert Q \vert}{\vert {Q}_{p}^{′} \vert} ; Q ⊆ {Q}_{p}^{′} ⊆ C . \qquad Formula 2$$

At operation 240, the processing device computes a cumulative popularity score for the first pattern in the plurality of clusters. The first pattern may have a high popularity score in the first cluster but a low popularity score in a second cluster of the plurality of clusters. The cumulative popularity score is used to determine an overall popularity of the identified first pattern across the entirety of the clusters from the query log.

As a phrase can be discussed across many clusters, for phrase p, a cumulative phrase score is computed as a summation of the pattern popularity scores by:

pₛₜ=Σ_{p∈C}pₛ. Formula 3:

A cumulative phrase score captures the overall popularity, support, and confidence of a pattern across the plurality of clusters in the received query log.

The processing device then extracts a set of URLs associated with the query-URL pairs for the first pattern at operation 242. As each pattern includes key words found in query-URL pairs of the query log, the URLs are extracted from the query-URL pair. In some embodiments, the URLs are maintained in a log for processing. The extracted URLs are then analyzed to identify a first sub-set of URLs originating from news domains from a plurality of preselected news domains at operation 244. For example, a log of URLs includes 6 URLs. Of the 6 URLs, 4 originate from news domains (e.g., CNN, NY Times, the Onion). Of the 4 URLs originating from news domains, 3 are from preselected news domains. The preselected news domains may be pre-screened and determined to be of verified and reliable news sources. Additionally, the preselected news domains may include news domains preferred by the user and stored in a profile specific to the user (e.g., user profiles 226, FIG. 7).

Based on a percentage of URLs of the first sub-set originating from news domains of the preselected news domain, the processing device assigns a news affinity score at operation 246. The news affinity score is reflective of an indication of how closely the first pattern is related to a news event. For example, a low news affinity score is received if the first sub-set of URLs does not include a high percentage (e.g., greater than 75%) of URLs originating from a preselected news domain. Typically, news domains output URLs for news-related articles or publications and the news affinity score is used to determine a level of news-relatedness of the identified first or subsequent pattern.

The processing device then generates a first news event profile for the first pattern at operation 248. The first news event profile includes one or more of the URLs from the original query-URL pairs. In some examples, the news event profile may include all of the URLs from the original query-URL pairs or a sub-set thereof. In some examples, the news event profile is populated with a dictionary include key words of the first pattern and a frequency count of the keywords found in the URLs of the news event profile. In some examples, the processing device identifies key words associated with the identified first pattern for each URL of the first sub-set of URLS and maintains a frequency count of each key word identified in the URLS of the first sub-set of URLs. The first news event profile may be generated including the key words associated with the identified first pattern and its corresponding frequency count.

In some embodiments, the news event profile includes key words extracted from the URLs, related URLs, any associated patterns, and any related queries.

At operation 250, the processing device causes one or more URLs of the first sub-set of URLS to be presented to the user. In some embodiments, the processing device may present the one or more URLs of the first sub-set of URLs in response to a user search request for a query including key words of the first news event profile.

For each time period, a distinct query log may exist. For example, a Monday query log is distinct from a Tuesday query log and also distinct from a Wednesday query log. It is understood that the time period for which a query log is received can be as small as a few minutes or as long as several days.

The operations of steps 232-248 may be repeated for multiple patterns to be identified and to generate multiple news event profiles across different time periods.

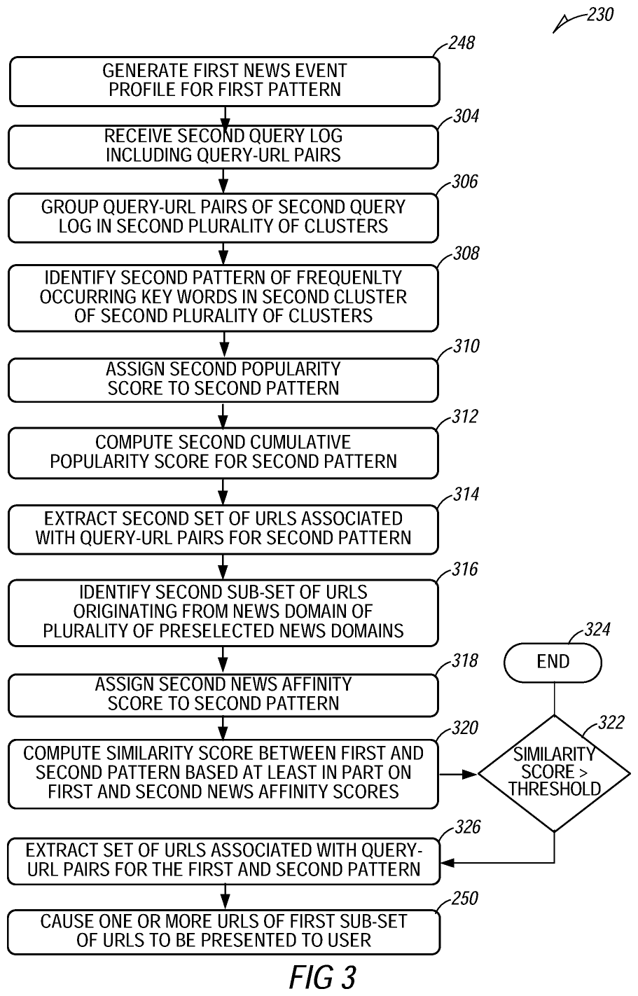

As described in FIG. 3, method 230 continues after the operation of generating the first news event profile for the first pattern (operation 248). The processing device at operation 304 may receive a second query log including query-URL pairs for a second time period (e.g., 24 hours after the first time period). In some embodiments, the processing device groups the query-URL pairs of the second query log into a second plurality of clusters at operation 306. The processing device at operation 308 identifies a second pattern of frequently occurring key words in a second cluster of the second plurality of clusters and assigns a second popularity score indicative of a frequency of the second pattern in the second cluster at operation 310.

At operation 312, the processing device then computes a second cumulative popularity score for the second pattern in the second plurality of clusters and extracts a second set of URLs associated with the query-URL pairs for the second pattern at operation 314. For the extracted set of URLs, the processing device at operation 316 identifies a second sub-set of URLS originating from a news domain of the plurality of preselected news domains and assigns a news affinity score to the second pattern at operation 318. The news affinity score is calculated based in part on a percentage of the URLs of the second sub-set of URLS originating from a news domain of the plurality of preselected news domains. The processing device at operation 320 then computes a similarity score between the first and the second patterns. The similarity score is computed at least in part on the first and second news affinity scores to determine whether the first and second patterns are related to news events. In response to a determination at operation 322 that the similarity score meets a threshold score, a set of URLs associated with the query-URL pairs for the first and second patterns are extracted at operation 326. In some embodiments, according to a determination that neither the first nor second patterns are news related events, the method 230 ends at operation 324. The method may be repeated for different patterns and/or for different time periods. The processing device then can cause one or more URLs of the first and/or second sub-set to be presented to the user at operation 250.

The similarity scores are used to determine how closely the patterns are related to news events. For example, a first pattern is for an event “Credit score” and a second pattern is for an event “pizza delivery.” The similarity scores for the respective patterns are used to filter out non-news related events. such as the first pattern for a “credit score” event. In some embodiments, further analysis is conducted to determine which pattern, (if any) is related to a news event. For example, a similarity score between a first and second pattern does not meet the threshold score. In such a scenario, each of the first and second patterns are determined individually whether the patterns are related to a news event. Typically, the similarity score comparison is computed for several patterns to filter out static events (e.g., non-news related events). “Bursty patterns” or patterns occurring over several days can be identified by:

(C−B)U((B′−A)∩C), Formula 4:
here B′ is the set of news related patterns found on day 1 and A is the set of patterns discovered on day 0.

In an example, on Monday, a query log of 1000 query-URL pairs are received. The 1000 query-URL pairs are grouped into 100 clusters of 10 query-URL pairs. Across the 100 clusters, 5 prominent patterns are identified. On Tuesday, another query log of 1000 query-URL pairs are received. The 1000 query-URL pairs from Tuesday are grouped into 100 clusters of 10 query-URL pairs. Across Tuesday's 100 clusters, 7 prominent patterns are identified. The prominent patterns from Monday (5 patterns) and Tuesday (7 patterns) are compared at least in part by using each patterns' news affinity score to filter out non-news related events. The patterns identified in Monday are also patterns identified in Tuesday at approximately the same news affinity score. By identifying patterns with similar news affinity scores and/or computing a similarity score between the patterns, it is possible to filter out static events. On any given day or time period, some identified patterns include frequently searched queries that are not news related such as credit scores, pizza delivery, etc. By comparing the news affinity scores of patterns from Monday and Tuesday, static events can be removed. Subsequently, the URLs for the patterns that have been determined to be news-related events may be provided for viewing to the user.

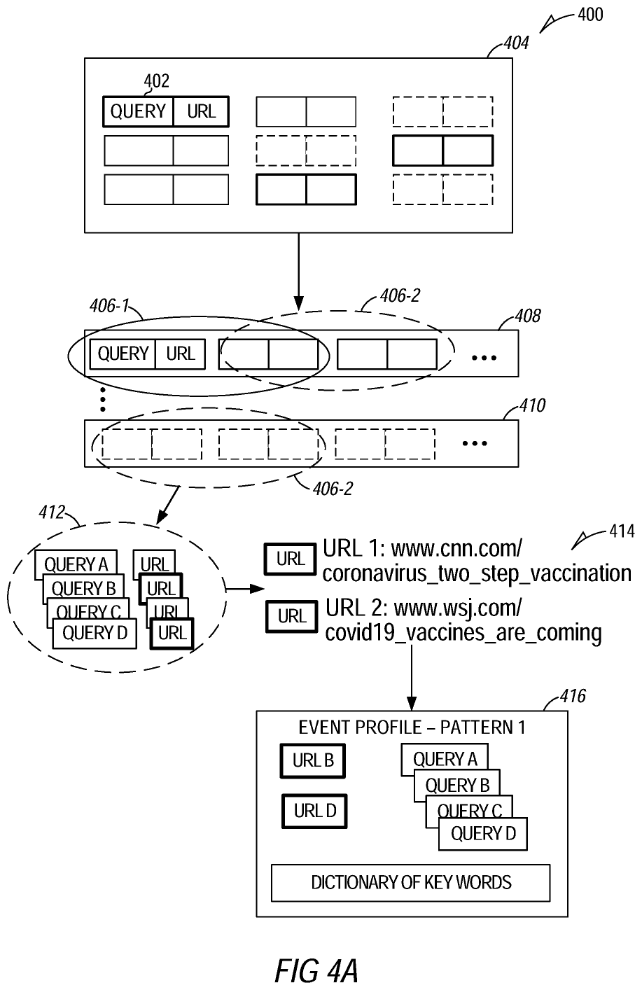

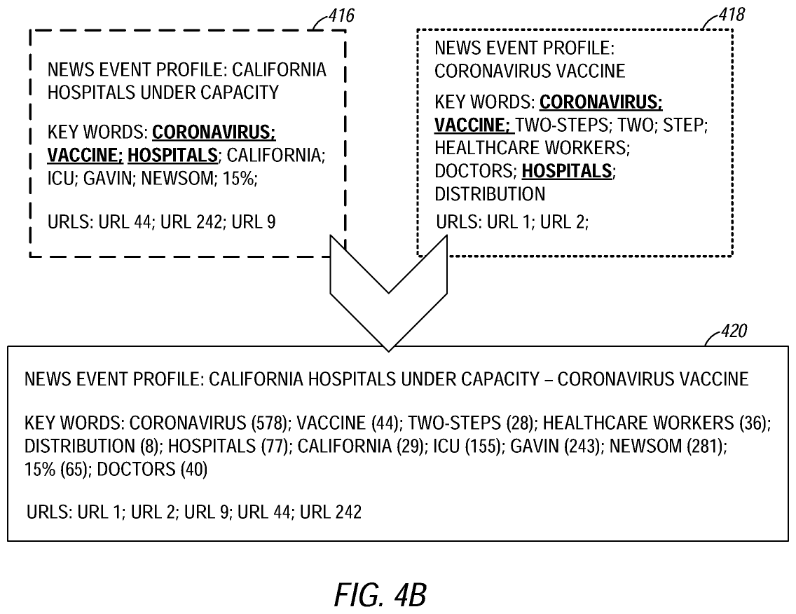

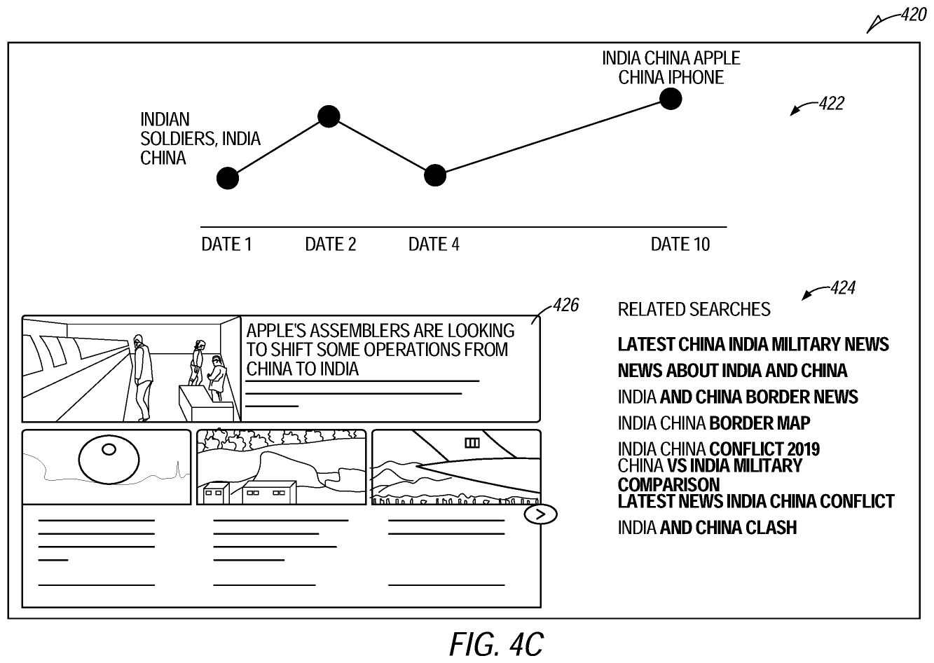

The processing device may additionally generate and provide the user with one or more event-based timelines. In some embodiments, the events associated with the event profiles are organized by date to create a visual timeline to be provided to a user of the client device. The visual timeline is discussed with more detail with regards to FIG. 4C herein.

The processing device may additionally provide the user with fresh query suggestions. In some embodiments, based on the identified patterns, one or more similar, fresh queries are provided as suggested queries. Fresh query suggestions and generations thereof is discussed with more detail with respect to FIG. 4C.

FIGS. 4A-4C show an example representation of how news event profiles are generated and presented for view. At 400 in FIG. 4A, one or more query-URL pairs 402 of a query log 404 are obtained for a specific time period (e.g., Day 1). The query-URL pairs 402 of the query log 404 are grouped into clusters 408, 410 based on common URLs. Each cluster is analyzed to identify a “bursty pattern” or a frequently occurring pattern of key words. Cluster 408 includes two distinct patterns, 406-1 and 406-2. Patterns can be discovered by identifying key words of each query and/or URL that occur frequently across multiple query-URL pairs. Each cluster may include multiple patterns, or none at all. For each identified pattern of a cluster, a popularity score is assigned based on the count of key words identified in the pattern. For example, cluster 408 includes pattern 406-2 having a high popularity score as the query-URL pairs include several overlapping (frequently occurring) key words. The popularity score for pattern 406-2 is calculated across all clusters of the query log 404. As shown, pattern 412 is an aggregate of query-URL pairs identified as pattern 406-2 in both cluster 408 and cluster 410. Of the identified pattern 412 across all clusters for the query log 404, the URLs of the query-URL pairs are analyzed to determine whether the URLs originate from a news domain. A further step may be implemented to determine the URLs originating from a news domain from a plurality of preselected news domains. From the URLs, a news event profile is generated. The news event profile may include a dictionary including the key words of the queries in the query-URL pairs, and key words found in the URL links themselves. The dictionary includes a frequency count of a number of times each key word appears in the URLs, queries, or both. Thus, news event profile 416 is generated from pattern 412 including various URLs and queries of the query-URL pairs from query log 404.

FIG. 4B shows an example representation of how news event profiles are merged to generate a comprehensive event profile. In view 422, news event profiles 417 and 418 have been generated using the processes described herein. A determination is to be made as to whether the news event profiles will be merged to generate a comprehensive event profile 420. If the news event profiles are to be merged, a pairwise Jaccard similarity score is computed between the patterns in consideration. Patterns with a Jaccard similarity score above 0.5 may be merged together. In some embodiments, news event profile 416 and 418 are generated within the same time period (e.g., same day). In some embodiments, news event profiles 416 and 418 are generated across different time periods (e.g., subsequent days). In either scenario, the news event profiles are to be merged to generate a comprehensive event including a holistic view of the event. In such instances, combining the news event profile would provide a user with richer details and more information. In some embodiments, a news event profile has an upper boundary of a number of URLs (e.g., 20 URLs). For such embodiments, a subset of identified URLs are ranked and the top 20 are selected for the news event profile.

As seen in FIG. 4B, news event profile 416 and 418 include overlapping key words such as “coronavirus”, “vaccine”, and “hospitals.” In some embodiments, news event profiles having an overlapping dictionary of key words at a specified percentage (e.g., 30%) causes the news event profiles to be merged. In some embodiments, other variables are considered to cause the news event profiles to be merged including (i) semantic similarity of the patterns, (ii) overlapping URLs, (iii) a high frequency of key words appearing in both dictionaries, or any suitable combinations or iterations of the variables described herein.

For example, multiple news event profiles are to be merged if the following conditions are met: (1) each news event profile was generated on the same day as all of the other news event profiles, (2) the percentage of overlapping key words is over a threshold (e.g., 25%), (3) the percentage of overlapping URLs is over a threshold (e.g., 2 or more URLs).

In some embodiments, if a news event continues to occur on a subsequent date, the news event profile evolves. In some embodiments, a news event profile is generated on Day 1 and subsequent query-URL pairs are added to the news event profile on Day 2. In some embodiments, news event profiles are merged to cover new aspects of the evolving news event. In some embodiments news event profiles are merged and given a new identity (e.g., news event profile 420 as a comprehensive news event profile of 416 and 418). Merging event profiles may be performed by simply adding the keywords and corresponding frequency and concatenating the URLs from the two event profiles.

Each subsequent update to the news event profile may be tracked and visually represented on an event timeline (e.g., timeline 422, FIG. 4C). In some examples, news event profiles are not merged together when the generation date of the news event profiles differ by a threshold (e.g., by three days). It is understood that multiple news event profiles can be combined to form a merged news event profile.

The one or more URLs may originate from reputable, or pre-selected news sources such as Wall Street Journal, New York Times, Cable News Network (CNN), National Broadcasting Company (NBC), National Public Radio (NPR). The news sources may pre-determined as providing reputable news using various methodologies. Such pre-determined news sources may be vetted using a third party to determine the news sources do not provide “fake news” or other falsified news information. In some examples, a user can pre-select news providers. For example, a user prefers the writing styles of authors for the New York times or the Washington Post and indicates that the user would like to receive news related content from the identified providers.

FIG. 4C shows is an example user interface 428 showing a visual representation of a timeline including recent event information in accordance with some examples. User interface 428 may be a view on a client device of a web browser. Within user interface 428 is a generated timeline 422 visually indicating a sequence of events linked together spanning across multiple days. The timeline 422 may include annotations providing snippets of information about the news event.

Additionally, the timeline can be organized as a graph or plot that indicates an intensity of an event on a y-axis of the timeline. Time is represented on the x-axis. The intensity of the event corresponds to a number of news sources publishing news reports about the news event. The y-axis may be labeled with numbers, or the intensity number may be normalized such that the timeline represents relative intensities. In some examples, one or more URLs of each news event profile generated for the day is presented to the user to show an overview of news events that occurred on that day. In some examples, one or more URLs of a news event profile is shown in response to a user query including key words matching key words of an existing (previously generated) news event profile.

In some examples, the user receives a presentation of URLs that are ranked in descending order based on the URL originating from a popular news domain. Further, the URL having the highest ranking is presented to the user in a prominent manner (e.g., bold, large, center of vision). In some examples, the highest-ranking URL is presented to the user in conjunction with a corresponding photograph from the news article. In some examples, URLs are selected to provide a complete view of the news event including opposite points of view. This may be achieved by providing URLs corresponding to different subsets of key words associated with the news event profile. Correspondingly, URLs can be provided to focus on a specific viewpoint (e.g., conservative or liberal). The displayed URLs may also provide a view of how the event changed over time (e.g., by providing 1 URL per day of the event to allow the user to see how the event unfolded) or provide the user with the most recent content (e.g., providing the most recently published URLs first).

User interface 420 can include a section of related searches 424 that provides fresh search suggestions. The fresh search suggestions may be based on a received user query. The fresh search suggestions may also or alternatively be provided based on a similarity between the suggested search and the news event referenced in the timeline 422. Further, fresh search suggestions may include queries of query-URL pairs from a cluster of the plurality of clusters.

For example, pattern A is discovered in cluster 1 and a news event profile is generated for pattern A. A user submits a search query including key words from pattern A. correspondingly, URLs from the news event profile for pattern A are provided to the user. Additionally, similar queries from query-URL pairs of cluster 1 are provided to the user as a “fresh” search suggestion. The “fresh” search suggestions may also be found in various other clusters that include pattern A.

FIG. 4C also displays a timeline that provides a graphical representation of news events related to Indian soldiers in India as well as news events including both India and China. The related searches may provide search suggestions related to soldiers, India, China, any related terms, or any combination thereof.

Additionally, user interface 420 can include a mixed-media section 426 that provides a formatted view that provides previews of news articles related to the news event. The mixed-media section 326 can include videos, photos, audio, and text.

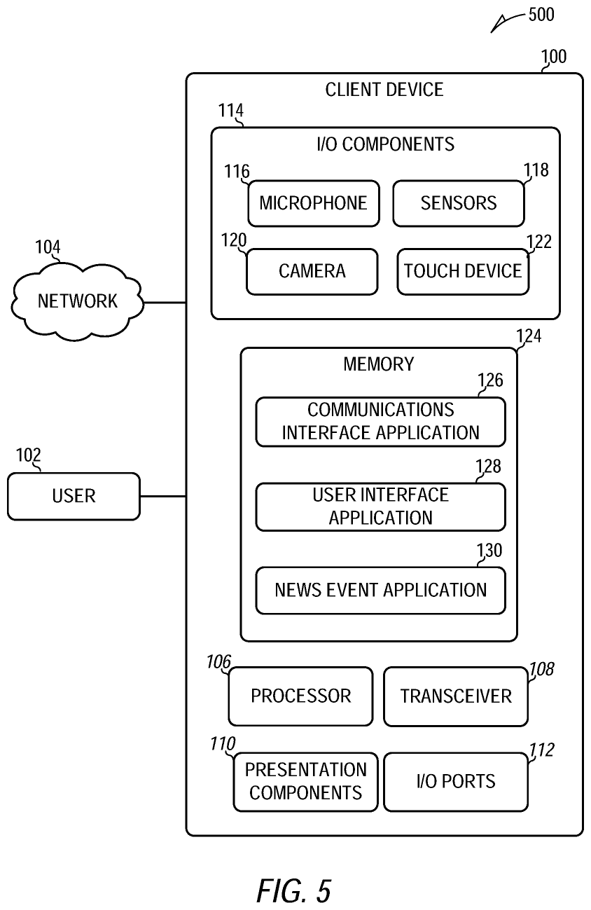

FIG. 5 depicts a block diagram 500 that illustrates an example client device 100 for collecting and providing user and environment data. In some examples, the client device 100 has at least one processor 106, a transceiver 108, one or more presentation components 110, one or more input/output (I/O) ports 112, one or more I/O components 114, and a memory 124.

The client device 100 may take the form of a mobile computing device or any other portable device, such as, a mobile telephone, laptop, tablet, computing pad, notebook, gaming device, portable media player, etc. The client device 100 may also include less portable devices such as desktop personal computers, kiosks, tabletop devices, industrial control devices, etc. Other examples may incorporate the client device 100 as part of a multi-device system in which two separate physical devices share or otherwise provide access to the illustrated components of the computing device 100.

The processor 106 may include any quantity of processing units and is programmed to execute computer-executable instructions for implementing aspects of the disclosure. The instructions may be performed by the processor or by multiple processors within the computing device or performed by a processor external to the computing device. In some examples, the processor 106 is programmed to execute methods such as the one illustrated in accompanying FIGS. 2-3.

Additionally, or alternatively, some examples may make the processor 106 programmed to present an experience in a user interface (“UI”), e.g., the UI shown in FIG. 4C. Moreover, in some examples, the processor 106 may represent an implementation of techniques to perform the operations described herein. For example, the operations may be performed by an analog client device 100 and/or a digital client device 100.

The transceiver 108 is an antenna capable of transmitting and receiving radio frequency (“RF”) signals. One skilled in the art will appreciate and understand that various antenna and corresponding chipsets may be used to provide communicative capabilities between the client device 100 and other remote devices. Examples are not limited to RF signaling, however, as various other communication modalities may alternatively be used.

The presentation components 110 visibly or audibly present information on the computing device 100. Examples of presentation components 110 include, without limitation, computer monitors, televisions, projectors, touch screens, phone displays, tablet displays, wearable device screens, televisions, speakers, vibrating devices, and any other devices configured to display, verbally communicate, or otherwise indicate image search results to a user. In some examples, the client device 100 may be a smart phone or a mobile tablet that includes speakers capable of playing audible search results to the user. In other examples, the client device 100 is a computer in a car that audibly presents search responses through a car speaker system, visually presents search responses on display screens in the car, e.g., situated in the car's dashboard, within headrests, on a drop-down screen, or the like, or a combination thereof. Other examples may present the disclosed search responses through various other display or audio presentation components 110.

I/O ports 112 allow the client device 100 to be logically coupled to other devices and I/O components 114, some of which may be built into client device 100 while others may be external. Specific to the examples discussed herein, I/O components 114 include a microphone 116, one or more sensors 118, a camera 120, and a touch device 122. The microphone 116 captures speech from the user 102 and/or speech of or by the user 102. The sensors 118 may include any number of sensors on or in a mobile computing device, electronic toy, gaming console, wearable device, television, vehicle, or other computing device 100. Additionally, the sensors 118 may include an accelerometer, magnetometer, pressure sensor, photometer, thermometer, global positioning system (“GPS”) chip or circuitry, bar scanner, biometric scanner for scanning fingerprint, palm print, blood, eye, or the like, gyroscope, near-field communication (“NFC”) receiver, or any other sensor configured to capture data from the user 102 or the environment. The camera 120 captures images or video of the user 102. The touch device 122 may include a touchpad, track pad, touch screen, or other touch-capturing device. The illustrated I/O components 114 are but one example of I/O components that may be included on the client device 100. Other examples may include additional or alternative I/O components 114, e.g., a sound card, a vibrating device, a scanner, a printer, a wireless communication module, or any other component for capturing information related to the user or the user's environment.

The memory 124 includes any quantity of memory associated with or accessible by the computing device 100. The memory 124 may be internal to the client device 100, as shown in FIG. 1, external to the client device 100, not shown in FIG. 1, or both. Examples of memory 124 may include, without limitation, random access memory (RAM), read only memory (ROM), electronically erasable programmable read only memory (EEPROM), flash memory or other memory technologies, CDROM, digital versatile disks (DVDs) or other optical or holographic media, magnetic cassettes, magnetic tape, magnetic disk storage or other magnetic storage devices, memory wired into an analog computing device, or any other medium for encoding desired information and for access by the client device 100. The terms computer-readable medium, machine readable medium, storage medium, and storage device do not include carrier waves to the extent carrier waves are deemed too transitory. Memory 124 may also take the form of volatile and/or nonvolatile memory; may be removable, non-removable, or a combination thereof; and may include various hardware devices, e.g., solid-state memory, hard drives, optical-disc drives, etc. Additionally, or alternatively, the memory 124 may be distributed across multiple client devices 100, e.g., in a virtualized environment in which instruction processing is carried out on multiple client devices 100. The memory 124 stores, among other data, various device applications that, when executed by the processor 106, operate to perform functionality on the computing device 100. Examples of applications may include search applications, instant messaging applications, electronic-mail application programs, web browsers, calendar application programs, address book application programs, messaging programs, media applications, location-based services, search programs, and the like. The applications may communicate with counterpart applications or services such as web services accessible via the network 104. For example, the applications may include client-operating applications that correspond to server-side applications executing on remote servers or computing devices in the cloud.

Specifically, instructions stored in memory 124 comprise a communications interface application 126, a user interface application 128, and a news event application 130. In some examples, the communications interface application 126 includes computer-executable instructions for operating a network interface card and/or a driver for operating the network interface card. Communication between the client device 100 and other devices may occur using any protocol or mechanism over a wired or wireless connection, or across the network 104. In some examples, the communications interface application 126 is operable with RF and short-range communication technologies using electronic tags, such as NFC tags, Bluetooth® brand tags, or the like.

In some examples, the user interface application 128 includes a graphics application for displaying data to the user and receiving data from the user. The user interface application 128 may also include computer-executable instructions for operating the graphics card to display search results and corresponding images or speech on or through the presentation components 110. The user interface application 128 may also interact with the various sensors 118 and camera 120 to both capture and present information through the presentation components 110.

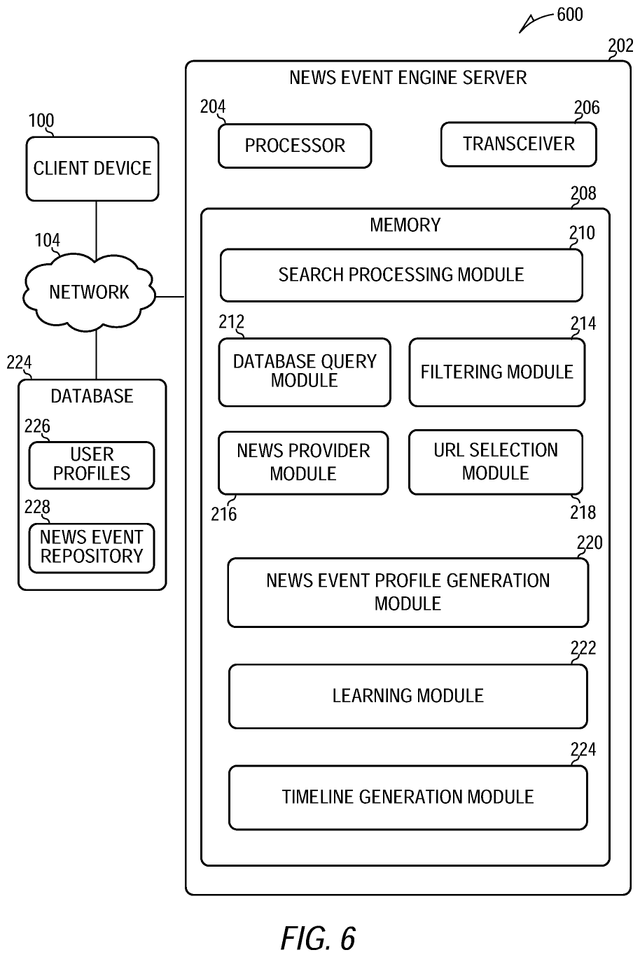

FIG. 6 is a block diagram of a networking environment 600 for providing image search results and recommendations on client device(s) 100. The networking environment 600 may include multiple client devices 100, or just one as shown in FIG. 6, a consumable item identification engine server 202, and a database 224 communicating over a network 104. In some examples, user and environment data are communicated by the client devices 100 over the network 104 to the consumable item identification engine server 202, and the consumable item identification engine server 202 generates tailored image search results that are provided back to the client devices 100 for presentation to their respective users 102.

The networking environment 600 shown in FIG. 6 is merely an example of one suitable computing system environment and is not intended to suggest any limitation as to the scope of use or functionality of examples disclosed herein. Neither should the illustrated networking environment 600 be interpreted as having any dependency or requirement related to any single component, module, index, or combination thereof.

The network 104 may include any computer network, for example the Internet, a private network, local area network (LAN), wide area network (WAN), or the like. The network 104 may include various network interfaces, adapters, modems, and other networking devices for communicatively connecting the client devices 100, the consumable item identification engine server 202, and the database 224. The network 104 may also include configurations for point-to-point connections. Computer networks are well known to one skilled in the art, and therefore do not need to be discussed in detail herein.

The client devices 100 may be any type of client device discussed above in reference to FIG. 5. Each client device 100 may capture user and/or environment data from their respective users and communicate the captured user and environment data over the network 104 to the consumable item identification engine server 202 and/or the database 224. To do so, each device may be equipped with a communications interface application 126, as discussed above in reference to FIG. 5. In response, the consumable item identification engine server 202 may be capable of providing intelligent image search results including restaurant, recipe, and ingredient recommendations to many client devices 100 capable of communicating their respectively captured user and environment data over the network 104. Put another way, the consumable item identification engine server 202 may control image searches on many client devices 100.

The client device 100 may be equipped with various software applications and presentation components 110 for receiving image-based search queries and presenting recommended restaurants to their respective users. For example, a mobile phone may present a search bar or search screen for image search. The search bar/screen can receive a user selected image of various image file types. The image is processed through various systems of identifying content in images. The search service may then provide an ordered list of restaurants that provide (e.g., serve) the same or similar food items identified in the user selected image. The illustrated client devices and the aforesaid presentation mechanisms are not an exhaustive list covering all examples. Many different variations of client devices 100 and presentation techniques may be used to deliver the image search result responses to users.

The news event engine server 202 represents a server or collection of servers configured to execute different web-service computer-executable instructions. The news event engine server 202 includes a processor 204 to process executable instructions, a transceiver 206 to communicate over the network 104, and a memory 208 embodied with at least the following executable instructions: an search processing module 210, a news event profile generation module 220, and a learning module 222. The memory 208 may include instructions for database query module 212, filtering module 214, news provider module 216, and a URL selection module 218. While news event engine server 202 is illustrated as a single box, one skilled in the art will appreciate that the consumable item identification engine server 202 may, in fact, be scalable. For example, the news event engine server 202 may include multiple servers operating various portions of software that collectively generate image search results on the client devices 100.

The database 224 provides backend storage of Web, user, and environment data that may be accessed over the network 104 by the consumable item identification engine server 202 or the client devices 100 and used by the consumable item identification engine server 202 to generate search results. The Web, user, and environment data stored in the database includes, for example but without limitation, user profiles 226, news events 228 and so on. Additionally, though not shown for the sake of clarity, the servers of the database 224 may include their own processors, transceivers, and memory. Also, networking environment 800 depicts the database 224 as a collection of separate devices from the consumable item identification engine server 202; however, examples may actually store the discussed Web, user, and environment data shown in the database 224 on the consumable item identification engine server 202.

Herein, a “user profile” refers to an electronically stored collection of information related to the user. Such information may include the user's name, age, gender, height, weight, demographics, current location, residency, citizenship, family, friends, schooling, occupation, hobbies, skills, interests, Web searches, health information, birthday, anniversary, celebrated holidays, moods, user's condition, and any other personalized information associated with the user. The user profile includes static profile elements, e.g., name, birthplace, etc., and dynamic profile elements that change over time, e.g., residency, age, condition, etc. The user profile may be built through probing questions to the user or through analyzing the user's behavior on one or more client devices.

Additionally, user profiles 226 may include static and/or dynamic data parameters for individual users. Examples of user profile data include, without limitation, a user's age, gender, race, name, location, interests, Web search history, social media connections and interactions, purchase history, routine behavior, jobs, or virtually any unique data points specific to the user. The user profiles 226 may be expanded to encompass various other aspects of a user's life.

The present disclosure relates to systems and methods for providing recent event information to a user according to at least the examples provided in the sections below:

(A1) In one aspect, some embodiments or example include a method of . . . . The method is performed at a client device (e.g., 102) in data communication with a network (e.g., 106). The method includes (i) receiving a query log (e.g., query log 404) including query-URL pairs for a first time period, (ii) grouping the query-URL pairs of the query log into a plurality of clusters, (iii) identifying a first pattern of frequently occurring key words in a first cluster of the plurality of clusters, (iv) assigning a popularity score indicative of a frequency of the first pattern in the first cluster, (v) computing a cumulative popularity score for the first pattern in the plurality of clusters, (vi) extracting a set of URLs associated with the query-URL pairs for the first pattern, (vii) identifying a first sub-set of URLs originating from a news domain of a plurality of preselected news domains for the extracted set of URLs, (viii) assigning a news affinity score to the pattern based at least in part on a percentage of URLS of the first sub-set of URLS originating from a news domain of the plurality of preselected news domains, (ix) generating a first news event profile for the first pattern, and (x) causing one or more URLs of the first sub-set of URLs to be presented to a user.

(A2) In some embodiments of A1, the method includes (i) receiving a second query log including query-URL pairs for a second time period, (ii) grouping the query-URL pairs of the second query log into a second plurality of clusters, (iii) identifying a second pattern of frequently occurring key words in a second cluster of the second plurality of clusters, (iv) assigning a second popularity score indicative of a frequency of the second pattern in the second cluster, (v) computing a second cumulative popularity score for the second pattern in the second plurality of clusters, (vi) extracting a second set of URLs associated with the query-URL pairs for the second pattern, (vii) for the extracted second set of URLs, identifying a second sub-set of URLs originating from a news domain of the plurality of preselected news domains, (viii) assigning a second news affinity score to the second pattern based at least in part on a percentage of URLS of the second sub-set of URLS originating from a news domain of the plurality of preselected news domains, (ix) computing a similarity score between the first and second pattern, the similarity score based at least in part on the first news affinity score and the second news affinity score, and (x) in response to a determination that the similarity score meets a threshold score, extracting a set of URLs associated with the query-URL pairs for the first pattern and second pattern.

(A3) In some embodiment of A1-A2, the method includes grouping of query-URL pairs into clusters includes identifying query-URL pairs with a common URL.

(A4) In some embodiment of A1-A3, wherein generating the news event profile for the pattern further includes (i) identifying key words associated with the identified first pattern for each URL of the first sub-set of URLs, (ii) maintaining a frequency count of each key word identified in the URLs of the first sub-set of URLs, and (iii) generating the first news event profile for the pattern including the key words associated with the identified first pattern and its corresponding frequency count.

(A5) In some embodiment of A1-A4, the method includes (i) identifying a plurality of news event profiles generated for the query log, (ii) determining an overlap exists among two or more news event profiles of the plurality of news event profiles, and (iii) in accordance with a determination that the overlap meets a threshold overlap, merging the two or more news event profiles into an updated news event profile.

(A6) In some embodiment of A1-A5, the method includes (i) performing operations for generating a third pattern for a third query log for a third time period, (ii) identifying that the third pattern from a third news event profile of the third query log matches a previously identified pattern of the first news event profile, and (iii) linking the third news event profile with the first news event profile.

(A7) In some embodiment of A1-A6, the method includes generating an interactive interface to be presented to the user, the interactive interface including a sequentially displayed organization of content corresponding to the first and third news event profiles.

(A8) In some embodiment of A1-A7, the interactive interface is a timeline, and the content includes one or more URLs of the first news event profile and one or more URLs of the third news event profiles.

(A9) In some embodiment of A1-A8, the content includes one or more query suggestions selected from the first cluster.

(A10) In some embodiment of A1-A9, the method includes (i) receiving a search query from a user, the search query including key words associated with the first pattern, (ii) identifying the first news event profile corresponding to the first pattern, and (iii) providing to the user, one or more URLs from the first sub-set of URLs of the first news event profile.

(A11) in some embodiment of A1-A10, wherein causing one or more URLs of the first sub-set of URLs to be presented to a user further comprises (i) ranking the one or more URLs of the first sub-set of URLs in descending order based on the URL originating from a popular news domain, and (ii) causing a URL having the highest ranking to be presented to the user in a prominent manner.

(A12) In some embodiment of A1-A10, the highest-ranking URL is a link to a news article.

(A13) In some embodiment of A1-A12, the highest-ranking URL is presented to the user in conjunction with a corresponding photograph from the news article.

In yet another aspect, some embodiments include a non-transitory computer-readable storage medium storing one or more programs for execution by one or more processors of a storage device, the one or more programs including instructions for performing any of the methods described herein (e.g., A1-A13 described above).

(B1) in yet another aspect, some embodiments include a method of generating a query, including (i) identifying, from a query log of a temporal period, one or more search queries occurring frequently in the query log during the temporal period, each search query having one or more key words, (ii) maintaining, for each of the one or more search queries, a frequency count of the search query occurring in the query log; selecting, a first group of search queries of the one or more search queries having a frequency count higher than a threshold count, (iii) identifying, a plurality of uniform resource locators (URLs) associated with one or more preselected news sources; matching, one or more URLs of the plurality of URLs based on text of the URLs corresponding to one or more key words associated with one or more search queries of the first group of search queries, (iv) generating a news event profile for each search query of the first group having at least one matching URL; adding each of the matching URLs into a respective news event profile, (v) receiving a query from a user having one or more key words, (vi) identifying, a matching news event profile including URLs matching one or more key words of the received query, (vii) determining, based on a comparison of the one or more key words of the received query and text of URLs in the matching news event profile that the received query corresponds to the matching news event profile, and (viii) causing URLs of the matching news event profile and one or more related search queries from the first group of search queries to be presented to the user in response to receiving the query.

(B2) In some embodiments of B1, wherein the query log includes user queries received within a previous three-day time period.

(B3) In some embodiments of B1-B2, wherein each of the preselected news sources are selected from a plurality of news sources that have been pre-determined to provide reliable news-related information.

(B4) In some embodiments of B1-B3, wherein each of the news event profiles includes key words selected from one or more words of text from the URLs.

(B5) In some embodiments of B1-B4, wherein determining that the received query corresponds to the matching news event further comprises: (i) comparing the received query to the plurality of key words of a news event profile, and (ii) determining, whether the key words of the received query match at least one or more keywords of the news event profile.

(B6) In some embodiments of B1-B5, wherein each of the plurality of related search queries includes one or more key words matching the one or more key words of the received query.

(B7) In some embodiments of B1-B6, wherein each related search query includes a corresponding URL associated with a news source.

(B8) In some embodiments of B1-B7, wherein causing the plurality of related search queries to be presented to the user in response to receiving the query further comprises causing the plurality of URLs associated with the search query to be presented to the user.

(B9) In some embodiments of B1-B8, wherein the plurality of related search queries is provided in a descending order based at least in part on an age of the URL.

(B10) In some embodiments of B1-B9, the method further comprises selecting, a first group of URLs from the plurality of URLs, each URL having a creation date within the temporal period.

(B11) In some embodiments of B1-B10 wherein each related search query to be presented to the user is ranked in descending order based at least in part on a calculation of relatedness of each query suggestion to the text received in the query from the user.

(B12) In some embodiments of B1-B11, wherein causing the URLs and related search queries to be presented to the user in response to receiving the query further comprises presenting a graphical user interface of a timeline corresponding to a time of an occurrence of the event for each related query suggestion.

(B13) In some embodiments of B1-B12, the method further comprises adding the key words of the received user search query to the matching event profile.

In yet another aspect, a system, comprising: a processor; and a memory device coupled to the processor and having a program stored thereon for execution by the processor to perform operations comprising any of the methods of B1-B13.

In yet another aspect, a non-transitory computer readable storage medium storing one or more programs, the one or more programs comprising instructions which when executed by one or more processors of an electronic device, cause the electronic device to perform any of the methods of B1-B13.

In yet another aspect, (C1) includes a method of generating search suggestions, including (i) identifying, from a query log, a plurality of potential events; identifying a dynamic news event from the plurality of potential events based on text from a plurality of uniform resource locators (URLs), each URL associated with an identified news source, (ii) generating a profile for the dynamic news event, the profile including a plurality of keywords, (iii) receiving a query from a user; determining based on a comparison of the query to the profile that the query corresponds to the dynamic news event, (iv) generating a plurality of query suggestions for the dynamic news event based on a concept extracted from the profile, and (v) causing the plurality of query suggestions to be presented to the user in response to receiving the query.

(C2) In some embodiments of C1, the query log includes user queries received in a specified time period.

(C3) In some embodiments of C1-C2, the identified news source is selected from a plurality of news sources that have been pre-determined to provide reliable news related information.

(C4) In some embodiments of C1-C3, the profile for the dynamic news event includes keywords selected from one or more words of text from the URLs.

(C5) In some embodiments of C1-C4, the method includes determining that the query corresponds to the dynamic news event including: (i) comparing the query to the plurality of keywords of the profile, (ii) determining, whether the query matches at least one or more keywords of the profile, and (iii) in accordance with a determination that the query matches at least one or more keywords of the profile, generating the plurality of query suggestions.

(C6) In some embodiments of C1-C5, wherein each of the plurality of query suggestions includes one or more keywords of the profile or text received in the query from the user.

(C7) In some embodiments of C1-C6, wherein each query suggestion of the plurality of query suggestions includes a corresponding URL associated with a news source.

(C8) In some embodiments of C1-C7, wherein causing the plurality of query suggestions to be presented to the user in response to receiving the query further comprises causing the plurality of corresponding URLs associated with the query suggestions to be presented to the user.

(C9) In some embodiments of C1-C8, wherein the plurality of query suggestions is ranked in descending order based at least in part on an age of the URL.

(C10) In some embodiments of C1-C9, the method further comprises associating the plurality of URLs with the profile for the dynamic news event and causing the plurality of query suggestions to be presented to the user further includes causing one or more URLs of the plurality of URLs to be presented to the user.

(C11) In some embodiments of C1-C10, wherein each query suggestion of the plurality of query suggestions are ranked in descending order based at least in part on a calculation of relatedness of each query suggestion to the text received in the query from the user.

(C12) In some embodiments of C1-C11, wherein causing the plurality of query suggestions to be presented to the user in response to receiving the query further includes presenting a graphical user interface of a timeline corresponding to a time of an occurrence of the event for each query suggestion.

(C13) In some embodiments of C1-C12, wherein generating a plurality of query suggestions for the dynamic news event further comprises: (i) determining, for each of the query suggestions that the query suggestion is related to a dynamic news event, (ii) after a determination for each of the query suggestions that the query suggestion is related to a dynamic news event, (iii) causing the plurality of query suggestions to be presented to the user in response to receiving the query.

In yet another aspect, a system, comprising: a processor; and a memory device coupled to the processor and having a program stored thereon for execution by the processor to perform operations comprising any of the methods of C1-C13.

In yet another aspect, a non-transitory computer readable storage medium storing one or more programs, the one or more programs comprising instructions which when executed by one or more processors of an electronic device, cause the electronic device to perform any of the methods of C1-C13.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

In the description herein, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

What is claimed is:

1. A computer-implemented method, comprising:
receiving a query log including query-URL pairs for a first time period;
grouping the query-URL pairs of the query log into a plurality of clusters;
identifying a first pattern of frequently occurring key words in a first cluster of the plurality of clusters;
assigning a popularity score indicative of a frequency of the first pattern in the first cluster;
computing a cumulative popularity score for the first pattern in the plurality of clusters;
extracting a set of URLs associated with the query-URL pairs for the first pattern;
for the extracted set of URLs, identifying a first sub-set of URLs originating from a news domain of a plurality of preselected news domains;
assigning a news affinity score to the pattern based at least in part on a percentage of URLS of the first sub-set of URLS originating from a news domain of the plurality of preselected news domains;
generating a first news event profile for the first pattern; and
causing one or more URLs of the first sub-set of URLs to be presented to a user in response to a user search request for a query including key words of the first news event profile.

2. The method of claim 1, further comprising:
in response to computing the cumulative popularity score for the first pattern:
receiving a second query log including query-URL pairs for a second time period;
grouping the query-URL pairs of the second query log into a second plurality of clusters;
identifying a second pattern of frequently occurring key words in a second cluster of the second plurality of clusters;
assigning a second popularity score indicative of a frequency of the second pattern in the second cluster;
computing a second cumulative popularity score for the second pattern in the second plurality of clusters;
extracting a second set of URLs associated with the query-URL pairs for the second pattern;
for the extracted second set of URLs, identifying a second sub-set of URLs originating from a news domain of the plurality of preselected news domains;
assigning a second news affinity score to the second pattern based at least in part on a percentage of URLS of the second sub-set of URLS originating from a news domain of the plurality of preselected news domains;
computing a similarity score between the first and second pattern, the similarity score based at least in part on the first news affinity score and the second news affinity score; and
in response to a determination that the similarity score meets a threshold score, extracting a set of URLs associated with the query-URL pairs for the first pattern and second pattern.

3. The method of claim 1, wherein grouping of query-URL pairs into clusters includes identifying query-URL pairs with a common URL.

4. The method of claim 1, wherein generating the news event profile for the pattern further comprises:
identifying key words associated with the identified first pattern for each URL of the first sub-set of URLs;
maintaining a frequency count of each key word identified in the URLs of the first sub-set of URLs; and
generating the first news event profile for the pattern including the key words associated with the identified first pattern and its corresponding frequency count.

5. The method of claim 4, further comprising:
identifying a plurality of news event profiles generated for the query log;
determining an overlap exists among two or more news event profiles of the plurality of news event profiles; and
in accordance with a determination that the overlap meets a threshold overlap, merging the two or more news event profiles into an updated news event profile.

6. The method of claim 5, further comprising:
performing operations for generating a third pattern for a third query log for a third time period;
identifying that the third pattern from a third news event profile of the third query log matches a previously identified pattern of the first news event profile; and
linking the third news event profile with the first news event profile.

7. The method of claim 6, further comprising:
generating an interactive interface to be presented to the user, the interactive interface including a sequentially displayed organization of content corresponding to the first and third news event profiles.

8. The method of claim 7, wherein the interactive interface is a timeline, and the content includes one or more URLs of the first news event profile and one or more URLs of the third news event profiles.

9. The method of claim 7, wherein the content includes one or more query suggestions selected from the first cluster.

10. The method of claim 4, wherein causing one or more URLs of the first sub-set of URLs to be presented to a user further comprises:
receiving a search query from a user, the search query including key words associated with the first pattern;
identifying the first news event profile corresponding to the first pattern; and
providing to the user, one or more URLs from the first sub-set of URLs of the first news event profile.

11. The method of claim 1, wherein causing one or more URLs of the first sub-set of URLs to be presented to a user further comprises:
ranking the one or more URLs of the first sub-set of URLs in descending order based on the URL originating from a popular news domain; and
causing a URL having a highest ranking to be presented to the user in a prominent manner.

12. The method of claim 11, wherein the highest-ranking URL is a link to a news article.

13. The method of claim 12, wherein the highest-ranking URL is presented to the user in conjunction with a corresponding photograph from the news article.

14. A system, comprising:
a processor; and
a memory device coupled to the processor and having a program stored thereon for execution by the processor to perform operations comprising any of the methods of claims 1-13.

15. A computer readable storage medium storing one or more programs, the one or more programs comprising instructions which when executed by one or more processors of an electronic device, cause the electronic device to perform any of the methods of claims 1-13.
